(19) United States
(12) Patent Application Publication
(10) Pub. No.: US 2011/0050708 A1
(43) Pub. Date: Mar. 3, 2011

(54) DISPLAY DEVICE AND DISPLAY METHOD

(75) Inventor: Masatoshi WATANABE, Ushiku (JP)

(73) Assignee: HITACHI, LTD., Tokyo (JP)

(21) Appl. No.: 12/860,963

(22) Filed: Aug. 23, 2010

(30) Foreign Application Priority Data
Aug. 27, 2009 (JP) 2009-196212

(51) Int. Cl. G06T 1/00

(52) U.S. Cl. 345/501

(57) ABSTRACT

A display device and a display method, for displaying configuration data of plural numbers of targets on a screen, in a region divided by rectangular parallelepipeds, comprises a processing unit, which is configured to form data having a Bit number corresponding to a number of pieces of the plural numbers of targets, and to recognize an existence of the configuration data of the plural numbers of targets, for each of the rectangular parallelepipeds divided, and to reflect the existence of the configuration data recognized on the Bit data, and an output unit, which is configured to output the Bit data reflected, and thereby to display it on the screen; thereby enabling to reduce the memory regions, while holding the configuration data holding a contacting or overlapping condition of the plural numbers of targets on a less memory region.

This application relates to and claims priority from Japanese Patent Application No. 2009-196212 filed on Aug. 27, 2009, the entire disclosure of which is incorporated herein by reference.

### BACKGROUND OF THE INVENTION

The present invention relates to a display device and a display method for displaying two (2) or more objects or targets, with determining a positional relationship between those targets, from surfaces of the targets or volume data thereof.

The inventors of the present invention created an idea and published it, relating to a method for executing thermo-fluid analysis upon a Cartesian coordinate grid, with using configuration data, which is outputted from 3D-CAD data, in the following Non-Patent Documents 1 and 2, etc.

This method is for executing a numerical simulation of thermal-fluid phenomenon in an inside or outside of a target, upon a computer, approximating surface configurations or geometries of the target to a rectangular parallelepiped, by putting surface data of the target within a region obtained by dividing a 3-dimensional space into fine rectangular parallelepipeds, and considering the rectangular parallelepipeds, which the surface comes contact with or cuts, as a surface of the target.

If possible to approximate the surface geometry, an inside/outside determination of the target, which is defined or constructed by closing curved surfaces, can be made through, for example, a scan-line method or a seed fill method, etc., which are already known, in general.

As is mentioned in “Numerical Heat Transfer and Fluid Flow”, the numerical analysis can be made while recognizing a fluid or a solid, by reserving a flag number for discriminating the solid or the fluid in a memory region thereof, with provision of the memory regions corresponding to a number of the rectangular parallelepipeds (when using a computer language, maintaining the memory regions as an array) . Also, with replacement of such flag numbers with object numbers for discriminating the targets, and also granting appropriate physical property values to the target numbers, it is possible to execute the numerical analysis, easily, by taking the physical property thereof into the consideration, even for a target having complex geometry.

In an actual numerical analysis, there are cases where plural numbers of targets are in contact with each other, or overlap each other, then it is necessary to memorize an existence of two (2) more numbers of targets, for each one of the rectangular parallelepipeds.

For example, in the following Patent Document 1 is disclosed a method for analyzing position information for each target, from the difference of the position information of a video at each time, while granting a time number to the position information (i.e., video information) , which is constructed by the target as a whole at each time, in case where plural numbers of articles change the positions thereof from time to time. However, even in this case, it is necessary to take out information relating, such as, a condition of overlapping or contact within a pixel size, through any other method.

<Prior Art Documents>

<Patent Documents>

[Patent Document 1] Japanese Patent Laying-Open No. Sho 63-246678 (1988).

<Non-Patent Documents>

[Non-Patent Document 1] Numerical simulation of Unsteady Turbulent Flow by Voxel Method, JSME international journal. Ser. B, Fluids and thermal engineering Vol. 47, No. 3 (20040815) pp. 477-482;

[Non-Patent Document 2] NUMERICAL SIMULATION OF FLOW AND HEAT TRANSFER OF LCD PROJECTOR USING VOXEL MEHTOD Nihon Kikai Gakkai Nenji Taikai Koen Ronbunshu Vol. 2004; NO. Vol. 6; PAGE. 61-62 (2004); and

[Non-Patent Document 3] Numerical Heat Transfer and Fluid Flow Suhas V. Patankar Taylor & Francis, pp 146-149, 1980

### BRIEF SUMMARY OF THE INVENTION

In the Patent Document 1 is disclosed the method for dividing or cutting out the plural numbers of targets, if there is the position information at plural numbers of times (hereinafter, being called “video information”, including the Patent Document 1). However, if the plural numbers of targets keep having the overlapping, for example, since an equal time number is kept granted even for the video at each time, it is difficult to obtain the information of an overlapping region. Also, when the plural numbers of targets do the same motion, they are acknowledged or recognized to be one (1) target.

Further,for obtaining information of the target, since there is necessity of plural numbers of video information at plural numbers of times, when considering the processing within a computing machine, the memory regions are necessary for those times, and this results suppression of the memory regions, which can be used for the numerical analysis.

Conventionally, as is disclosed in the Non-Patent Document 3, if it is possible to make two (2) kinds of determination, i.e., the solid and the fluid, for example, then it is enough for the numerical analysis of heats and fluids. However, a means having the following functions is strongly desired, for enabling to reemerge the configuration of the target, even if the targets are in contact with each other, or if the targets overlap on each other, in case when executing the numerical analysis upon the articles, which may move and deform:

(1) enabling to extract region (s) generating the contact (s) and/or the overlap (s), in case where the plural numbers of targets lie and they have contact(s) and/or overlap(s) with each other;

(2) enabling to recognize a position of contacting heat resistance in the heat transfer analysis, or a position where a boundary condition for a contacting condition should be applied in a structure analysis, between the configuration targets having complex geometries; and

(3) enabling to obtain the position information, respectively, in a shot time-period, when there are a still standing target and a moving target.

An object of the present invention is to provide a display device and a displaymethod for enabling to reduce the memory regions, by maintaining the configuration data keeping the contacting and/or overlapping condition (s) of the plural numbers of targets, on the less memory regions.

According to the present invention, for accomplishing the object mentioned above, there is provided a display device for displaying configuration data of plural numbers of targets on a screen, in a region divided by rectangular parallelepipeds, comprising: a processing unit, which is configured to form data having a Bit number corresponding to a number of pieces of said plural numbers of targets, and to recognize an existence of the configuration data of said plural numbers of targets, for each of said rectangular parallelepipeds divided, and to reflect the existence of the configuration data recognized on said Bit data; and an output unit, which is configured to output said Bit data reflected, and thereby to display it on said screen. Further, the display device as described in the above further comprises a memory unit, which is configured to memorize said Bit data reflected therein. Also, according to the present invention, there is provided a display method for displaying configuration data of plural numbers of targets on a screen, in a region divided by rectangular parallelepipeds, comprising the following steps of: a step for forming data having a Bit number corresponding to a number of pieces of said plural numbers of targets; a step for recognizing an existence of the configuration data of said plural numbers of targets, for each of said rectangular parallelepipeds divided; a step for reflecting the existence of said configuration data recognized upon said Bit data; and a step for displaying said Bit data reflected on said screen. Further, the display method as described in the above further comprises a step for memorizing said Bit data reflected.

According to the present invention, since the configuration data keeping the contacting and/or overlapping condition(s) of the plural numbers of targets, on the less memory regions, thereby it is possible to reduce the memory regions.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing a device for implementing the present invention in practice, according to an embodiment of the present invention;

FIG. 2 is a view for showing a flowchart of processes, according to the present invention;

FIG. 3 is a view for showing an example of dividing a rectangular parallelepiped in the processes, according to the present invention;

FIG. 4 is a view for showing an example of setting surface data in the processes, according to the present invention;

FIG. 5 is a view for showing a Bit expression after a volume search in the processes, according to the present invention;

FIG. 6 is a view for showing an example of setting plural numbers of configurations with the processes, according to the present invention;

FIG. 7 is a view for showing an example of Bit expression of a condition of setting the plural numbers of configurations with the processes, according to the present invention;

FIG. 8 is a view for showing an example of Bit expression after moving of the target with the processes, according to the present invention; and

FIG. 9 is a view for showing an example of applying the present invention on an actual thing.

### DETAILED DESCRIPTION OF THE PREFERRED EMBODIMENTS

Hereinafter, embodiments according to the present invention will be fully explained by referring to the attached drawings.

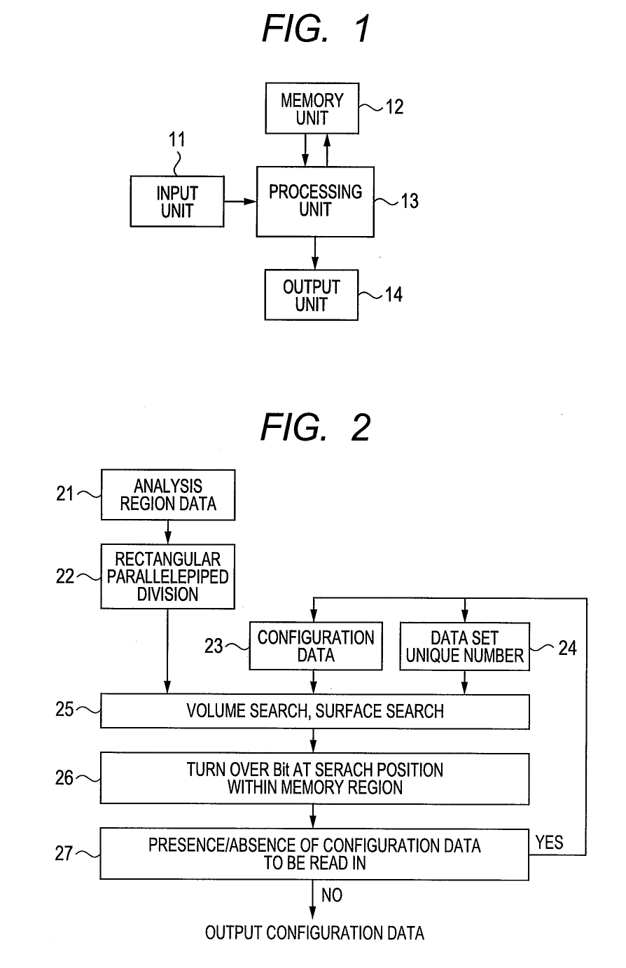

FIG. 1 is a view for showing a device for implementing the present invention in practice. As is shown in FIG. 1, this device comprises an input unit 11, including an input unit for inputting an analysis region, data for designating a division size of rectangular parallelepipeds, and for inputting a surface or volume data, a memory unit 12, a processing unit 13 and an output unit 14.

Thus, within a display device for displaying configuration data of pleural numbers of targets on a screen, in a region divided by the rectangular parallelepipeds, there are provided, at least, a processing unit 13 for generating data having a Bit number corresponding to a number of the plural numbers of targets, for recognizing existence of configuration data of those plural numbers of targets, for each of the rectangular parallelepipeds divided, and thereby reflecting the existence of the configuration data recognized upon this Bit data, and the output unit 14 for outputting this Bit data, which is reflected within the processing unit 13, to be displayed on the screen. Also, the memory unit 12 memorizes this Bit data, which is reflected within the processing unit 13, therein.

The input unit 11, including an input unit for inputting an analysis region, data for designating a division size of rectangular parallelepipeds, and for inputting a surface or volume data, is a keyboard or a mouse, and inputting is made with using a numerical value or a file name, into which the data is stored therein, etc.

The memory unit may be an external memory unit for memorizing data and/or program, such as, a hard disk drive or a solid state drive, etc., for example, or may be an internal memory unit for storing calculation information therein, such as, a RAM and/or a ROM, etc.

The processing unit 13 is a device for processing calculation and/or input/output data, such as a CPU (Central Processing Unit), GPGPU (General Purpose Graphics Processing Unit), etc ., for example, and it execute a program for processing configuration data production according to the present invention.

The output unit 14 is a video display device, etc., on which the configuration data produced is displayed thereon.

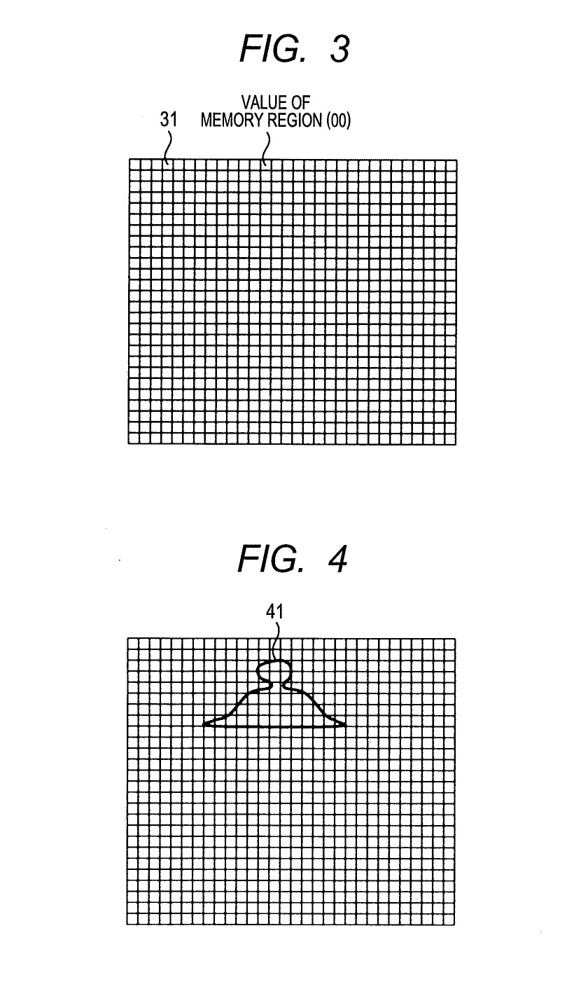

FIG. 2 shows a flow of a method according to the present invention, which will be processed inside the processing unit. FIGS. 3 to 7 are diagrammatical views for explaining the method according to the present invention in a 2-dimension.

In a analysis region data 21, a sixe of the analysis region, a number of division into the rectangular parallelepiped, a size of the rectangular parallelepiped, etc., are inputted into a computer.

With using that data, in a rectangular parallelepiped division 21, an analysis space is divided by the rectangular parallelepiped, and coordinate information of each of the rectangular parallelepipeds is produced, and also a memory region for a number of the rectangular parallelepipeds is kept on the computer, having a Bit length by the maximum number of a unique number of the configuration data to be read in. If necessary, all of Bits of the regions maintained are cleared into “0” or “1”.

FIG. 3 is a diagrammatic view of applying the memory regions to the rectangular parallelepiped division regions under the condition of clearing the Bit of the memory regions into “0”, while a number of the configuration data to be read in is two (2) and the unique numbers thereof are set to “1” and “2”, respectively.

In rectangular parallelepiped 31, the entire analysis regions are divided, and the memory regions corresponding to the respective rectangular parallelepipeds are “00” by Bit number 2. It is sufficient that the Bit number for the rectangular parallelepipeds prepared in the memory regions is equal or greater than the maximum value of the number of the configuration data or the unique number.

FIG. 4 is a view for showing the condition, after reading the configuration data 23 and the unique numbers 24 therein, where the configuration of the configuration data 41 of the unique number “1” is reflected on the analysis regions . However, in this condition, the memory region Bit is (00).

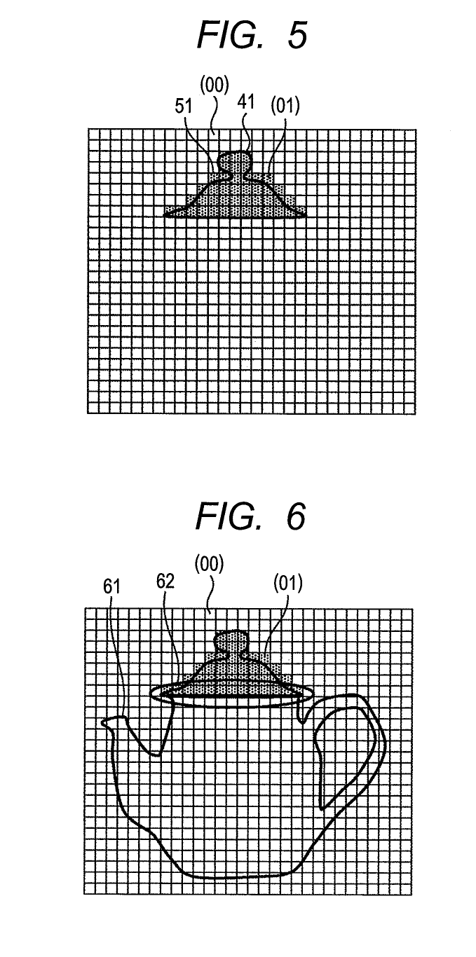

FIG. 5 is a view for showing the condition of the memory regions after completing a volume search and a surface search 25. When completing the surface and volume searches, the Bit of the rectangular parallelepiped, in which a contour or an outline of the configuration data 41 leis, and a portion of the rectangular parallelepiped included therein (configuration data existing region) 51 becomes (01), i.e., a first Bit is turned over, into “1”.

FIG. 6 is a view for showing the condition of reading the configuration data 61 of the unique number 2 therein, and reflecting the configuration data upon the analysis region. The structure of this article shows a main body of a pot and a cover thereof. For that reason, in an overlapping region 62, they are in a positional relationship that the main body and the cover overlap or contact with each other.

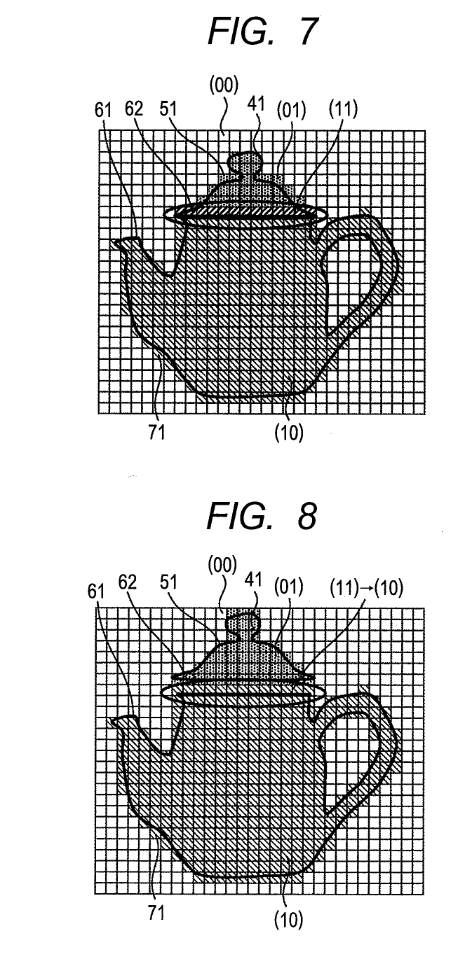

FIG. 7 is a view for showing the condition of the memory regions after completing the volume search and the surface search. When completing the volume search and the surface search, the Bit of the rectangular parallelepiped, in which the outline of the configuration data 61 lies, and a portion of the rectangular parallelepiped included therein (configuration data existing region) 71 becomes as follows; i.e., a second Bit is turned over, from “0” into “1”. In the overlapping region 62, since both of the configuration data 41 and 61 exist, then the Bit condition turns into (11).

With adopting such data structure therein, it is sufficient to see a first (1^{st}) Bit for the region where the configuration data 41 exists even or to see a second (2^{nd}) Bit for the region where the configuration data 61 exists, if there is the contacting or the overlapping; therefore it is possible to confirm the existence of the plural numbers of configurations, easily. Also, since the contacting or overlapping region is a region having “1” in two (2) or more of Bits, it is also possible to extract such region(s), easily. For this reason, if assuming that the output unit 14 in FIG. 1 is a video display device, it is possible to make a visual conformation thereof, easily.

For example, in case when trying to describe the region by a numerical value of itself, such as, the unique number, while granting or giving the unique number to the configuration data, then it can be considered to give either one of the numbers, in the overlapping region 62 shown in FIG. 7; however, in that case, the information of overlapping or contacting will be lost, and then it is necessary to execute the search, again, also on the region of the standstill configuration data 41, even in the case where only the configuration data 61, i.e., the cover, is moved or deformed.

Also, there can be also considered a method of expressing as a sum of the respective unique numbers; however, when reading three (3) pieces of configurations therein, there can be a case that 1 and 2 contact with, and the contact region is 1+2=3, as a considerable one if the contacting or the overlapping occurs, but in this case, it is difficult to determine if the unique number 3 exists or not, or it is the overlapping region.

In the case similar to that of the embodiment 1, there will be shown a case when an operation is made to move out the cover potion of the pot.

As is shown in FIG. 8, for the region of the standstill main body 61, it is sufficient to turn the first (1^{st}) Bit to “1”; there is no necessity of searching the region, again. Since the cover is far from the main body 61, the overlapping region 62 before movement is changed into the region where only the main body exists, i.e., into (10), as the Bit.

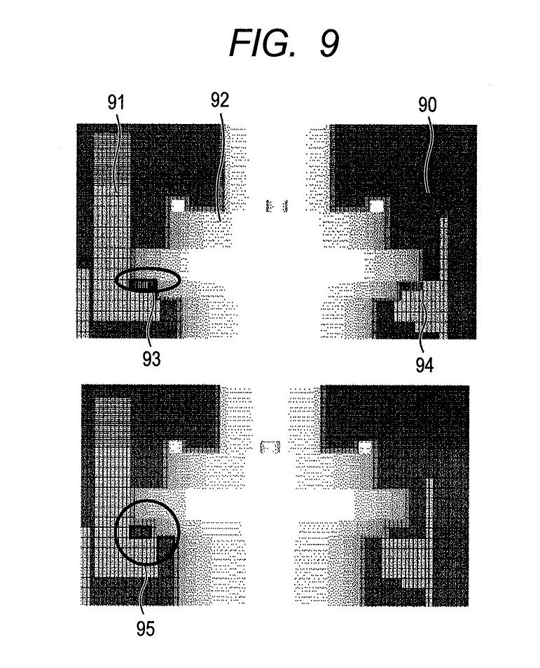

FIG. 9 is a view for showing an example of applying the present invention, when a cylinder-like mechanism portion 92 rises up while contacting on a support 91.

Grid-like lines 90 in FIG. 9 are boundary lines of the rectangular parallelepipeds. The cylinder part 92 is disposed on a collar portion 94 of the support 91, contacting thereon in a initial condition thereof. On the screen, since the region where the cylinder part exists is displayed with priority, the collar portion 94 is displayed to be step-like within a contact region 93 before movement (or, pre-movement contact region).

The condition of this place 93 after movement of the cylinder part 92 is a contact region 95 after movement (post-movement contact region) . Because the cylinder part 92 moves, the collar portion 94 of the support 91 appears, not to be step-like, but as a plane.

With the method according to the present invention, even if there are the configuration articles in plural numbers thereof, it is sufficient for the memory regions to have a Bit length of the number, i.e., (a number of rectangular parallelepipeds dividing the analysis region)×(a number of articles) , and thereby enabling to reduce a capacity of memory. Also, even in case where the article moves and deforms under the condition of having the contacting and the overlapping, since it is possible to remove or distinguish that article from the analysis region if making the Bit of the article moving or deforming, it is enough to execute the volume search and/or the surface search 25 shown in FIG. 2 upon only the article moving or deforming; thereby enabling to reduce a calculation load.

According to the present invention, since it is enough to execute the position search only upon the article moving or deforming, the motion of which can be reproduced with less capacity of the memory, it is applicable in a motion analysis of a mechanism apparatus, a determination of contact of a mechanism with motion simulation of a manufacturing apparatus, etc., and also in the fields, such as, a heat conduction analysis and a stress analysis, etc., for example.

As was mentioned above, within the embodiments 1 and 2, the display method for displaying the configuration data of the plural numbers of targets on a screen, comprises the following steps of: a step for producing data having a Bit number corresponding to a number of pieces of the plural numbers of targets; a step for recognizing existences of configuration data of those plural numbers of targets, for each of those rectangular parallelepipeds divided; a step for reflecting the existence of this configuration data recognized upon said Bit data, and a step for displaying said Bit data reflected on the screen. Further, it comprises a step for memorizing this Bit data reflected.

Also, there is provided a method for approximating a target configuration to a surface or a volume, with fine rectangular parallelepipeds, by diving an analysis region, upon which a numerical analysis should be executed, and also executing determination of crossing between surface data or volume data of the target, which can be obtained, separately, from 3D-CAD, etc., and the rectangular parallelepipeds, or an inclusion, i.e., a method for producing configuration data, holding information of contacting or overlapping from the surface data or the volume data, having the followings steps: a step for producing this analysis region on a memory regions inside a computer, and preparing memory regions corresponding to a number of fine rectangular parallelepipeds having a Bit number larger than the number of pieces of this surface data or the volume data, for example, an array, and dividing into rectangular parallelepiped regions; a step for reading this surface data or the volume data therein; a step for reading a number unique for the target with respect to this surface data or the volume data into the computer, and a step for searching a relationship of crossing or inclusion, between this surface data or the volume data and the rectangular parallelepiped produced within this analysis region, and turning over the Bit corresponding to the number unique for the target in the memory region corresponding to the rectangular parallelepiped.

Also, when a specific article moves or deforms, in the step for reading the number unique for the article with respect to the surface data or the volume data, according to the present invention, it is enough to search the relationship of crossing or inclusion of the rectangular parallelepiped produced within said analysis region, only upon the target, which changes the positional relationship and/or the configuration from time to time; i.e., there is provided a method for producing the configuration data, lightening a load in calculation, enabling with moving/deforming condition holding the contacting or overlapping information from the surface data or the volume data.

Also, by reading a boundary condition unique for the numerical analysis, into the contact region of the specific plural numbers of articles, i.e., the information showing a relevancy, such as, a contact heat resistance in the thermal analysis, a restriction condition, in the structure analysis, etc., for example, as additional data, in the step for reading the number unique for the target with respect to the surface data or the volume data, according to the present invention, there is provided a method for producing the configuration data, being applied with an appropriate boundary condition from the contacting or overlapping information held, according to the present invention, for a target having complex configuration or geometry, as well as, lightening a load in calculation, irrespective of change of the positional relationship at each time, for the target changing the positional relationship or the configuration thereof from time to time, and thereby corresponding to grant of the boundary condition of the contacting or overlapping portion between the surface data or the volume data themselves.

As was mentioned above, according to the present invention, the configuration data holding the contacting or overlapping condition of the plural numbers of target can be held on the less memory regions, and the memory regions can be reduced.

Also, since the configuration data holding the contacting or overlapping condition of the plural numbers of targets can be obtained, on a pre-stage of the analysis, it is possible to confirm if the respective targets are in contact with or not, in an unintentional manner, or have the overlapping, through the video display, and therefore checking can be made on if it is reproduced as the correct analysis model or not, also for the very complex analysis target.

Also, since the configuration data holding the contacting or overlapping condition of the plural numbers of targets is held within the memory regions, in the form of the Bit arrays corresponding to the number of the targets, for each of the rectangular parallelepipeds, when the target moves or deforms, it is possible to delete only the target from the analysis area, only by turning over the Bit corresponding to that target; i.e., it is enough to search the rectangular parallelepipeds corresponding thereto, upon only the target configuration after movement thereof, so as to turn over the Bit corresponding thereto, therefore, it is possible to produce the positional relationship of the target articles within the analysis area after the movement, in a shot time.

Also, even in case where the contacting or overlapping region is generated while the plural numbers of targets have contacting or overlapping, or accompanying with the movement thereof, it is possible to maintain an appropriate boundary condition, if relative positional relationships thereof are changed, by reading the boundary conditions necessary for analysis between the targets.

Such effect as was mentioned above can be used in a prior confirmation, if the analysis can be conducted correctly or not, by displaying the contacting or overlapping information on the video display device, and thereby enabling an avoidance of execution of an analysis, under the condition of being insufficient as the analysis model.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A display device for displaying configuration data of plural numbers of targets on a screen, in a region divided by rectangular parallelepipeds, comprising:
a processing unit, which is configured to form data having a Bit number corresponding to a number of pieces of said plural numbers of targets, and to recognize an existence of the configuration data of said plural numbers of targets, for each of said rectangular parallelepipeds divided, and to reflect the existence of the configuration data recognized on said Bit data; and
an output unit, which is configured to output said Bit data reflected, and thereby to display it on said screen.

2. The display device as described in the claim 1, further comprising:
a memory unit, which is configured to memorize said Bit data reflected therein.

3. A display method for displaying configuration data of plural numbers of targets on a screen, in a region divided by rectangular parallelepipeds, comprising the following steps of:
a step for forming data having a Bit number corresponding to a number of pieces of said plural numbers of targets;
a step for recognizing an existence of the configuration data of said plural numbers of targets, for each of said rectangular parallelepipeds divided;
a step for reflecting the existence of said configuration data recognized upon said Bit data; and
a step for displaying said Bit data reflected on said screen.

4. The display method as described in the claim 3, further comprising:
a step for memorizing said Bit data reflected.
